(19) United States
(12) Patent Application Publication
(10) Pub. No.: US 2003/0058752 A1
(43) Pub. Date: Mar. 27, 2003

(54) Apparatus and method for delivering psycho-suggestive messages

(76) Inventors: Stacy Birnbach, Potomac, MD (US); Hanlo Yao, (US)

Correspondence Address: Erik B. Cherdak & Associates, LLC, 11300 Rockville Pike, Suite 906, Rockville, MD, 20852, US

(21) Appl. No.: 09/963,091

(22) Filed: Sep. 25, 2001

(51) Int. Cl. G11B 31/00

(52) U.S. Cl. 369/19

(57) ABSTRACT

An apparatus and corresponding method for delivering a prerecorded psycho-suggestive message such as a pre-recorded motivational message (e.g., a sales incentivizing message, a spiritual message, etc.) to a person that includes and involves a personal electronic device configured to perform a function, a storage unit for digitally storing at least one pre-recorded psycho-suggestive message, and a playback unit for playing the prerecorded psycho-suggestive message(s) for perception by the person. The personal electronic device is prevented from performing its function when the playback unit plays the psycho-suggestive message(s). The personal electronic device may be a radio unit such as a water-resistant radio that may be used in a shower or other similar or like context.

### BACKGROUND OF THE INVENTION

1. Field of the Invention

The present invention relates to devices used to manifest and automatically play pre-recorded messages such as digitally recorded human understandable voice based and other messages. More particularly, the present invention relates to the automatic playback of psycho-suggestive and other motivational type messages such as pre-recorded digital motivational, inspirational, educational, etc. messages.

2. Description of the Related Art and the Problems Addressed

It is well known that human beings are by their very nature capable of achieving great things when possessed of the right state of mind. For example, professional athletes often engage in mind-based exercises in which they are instructed to envision success relative to particular endeavor or event. Olympic downhill skiers are often trained to mentally prepare for a sporting event by first learning a mountain course and then rehearsing their performance relative to that that course in their minds. As such, success or failure often will be attributed to one's mental strength relative to a particular field of endeavor.

Take sales personnel for example. Companies and organizations have long believed that the power of positive thinking is often the key to sales success. Each year organizations spend significant resources internally and for outside professional coaching services by recognized experts to mentally prepare sales personnel and to produce “winners”—sales people that are mentally prepared to realize a relatively greater number of sales and gains.

While many skeptics have said that positive thinking and sales and other performance success are merely coincidences, the power of positive thinking cannot be underestimated as a tool that everyday people can and should use to better their lives. For example, many people endlessly (and unnecessarily) seek the advice and care of medical practitioners often to “fix” problems that can be solved through simple positive thinking. We have all heard the stories of cancer patients that have long outlived prognoses for short life expectancies as a result of familial support and simple positive thinking wherein one can convince oneself that he or she can truly overcome particular obstacles and live stronger and healthier.

Despite the benefits that have long been attributed to positive thinking, there remain no truly effective way of delivering coaching and other messages to people outside of requiring people to read books by gurus, attend seminars, and the like. Aside from horoscopes and machines that may deliver the same such as in vending and entertainment machine contexts, there remains no effective way for people to receive psycho-suggestive and other motivational type coaching messages that are easily obtained and perceived.

Thus, there exists a need to provide new and improved apparatuses and corresponding methods that facilitate user friendly delivery of psycho-suggestive and other motivational messages that people can obtain and perceive to aid them in thinking more positively about their personnel challenges and about their personal circumstances.

### DESCRIPTION OF THE INVENTION

The present invention delivers a new apparatus and corresponding method which facilitate delivery of psycho-suggestive and other motivational message and which enable new products such as portable consumer electronics devices such as radios, personal games, media players (CD, DVD, MP3), etc. For example, a new radio may be outfitted in accordance with the present invention to be used in the sales and spiritual products marketplaces. Such a radio, for example, can now be configured to automatically play a new, unique pre-recorded, digital message of say 5-10 minutes, for example, everyday of the year. Such messages can be recorded by world-renowned experts in the fields of sales and spirituality.

For example, each morning when a user either wakes from sleep (such as a result of clock radio initiating manifestation of a radio broadcast) or gets into a shower stall where a shower radio is in operation, the user can be presented with a meditative/spiritual, sales, etc. message.

In a world often filled with negativity, where people are constantly on the run with no time for feeding themselves positive affirmations either through meditation or positive messages the present invention will allow users to incorporate these powerful and persuasive messages/affirmations into their lives easily and effectively.

As such, the present invention provides an apparatus and corresponding method for delivering a pre-recorded psycho-suggestive or other motivational message to a person that includes and involves one or more of the following components, e.g., a personal electronic device configured to perform a function (e.g., a radio that plays a radio broadcast, etc.), a storage unit for digitally storing at least one pre-recorded psycho-suggestive message, and a playback unit for playing the pre-recorded psycho-suggestive message(s) for perception by the person, and a control unit for selecting a predetermined psycho-suggestive message(s) to be played at a specific time and/or date. The personal electronic device may be prevented from performing its function when the playback unit plays the psycho-suggestive message(s). The personal electronic device may be a radio unit such as a water-resistant radio that may be used in a shower stall or other similar or like context.

### BRIEF DESCRIPTION OF THE DRAWING FIGURES

The present invention is described in detail below with regard to the attached drawing figures, of which:

FIG. 1 is block diagram of an apparatus, which facilitates delivery of psycho-suggestive and other motivational messages in accordance with a preferred embodiment of the present invention;

FIG. 2 is a diagram of a personal electronic device (e.g., a shower stall radio) that is equipped with an apparatus that facilitates delivery of psycho-suggestive and other motivational messages in accordance with a preferred embodiment of the present invention; and

FIG. 3 is a flowchart that illustrates the operations and processes that are carried out within the context of the present invention to facilitate delivery of psycho-suggestive and other motivational messages in accordance with a preferred embodiment of the present invention.

### DESCRIPTION OF THE INVENTION

Aspects of various embodiments of the present invention are now described in detail with reference to the drawing figures, which were briefly described above. Unless otherwise indicated, like parts and processes are referred to with like reference numerals.

In the context of the present invention, the term “psycho-suggestive message” is intended to mean any type of motivational, spiritual, or stimulating message that is intended to bring about a favorable response in an individual as well as feelings of greater hope and achievability (i.e., a more positive outlook on one's personal affairs). For examples, a sales like psycho-suggestive message may include statements directed to achieving a sales goal—“When working with your customers, answer their questions fairly and honestly, address their needs, demonstrate the benefits of your company's products over weaker competitors, and close the transaction—you can do it!” A spiritual message may be religious in nature such as a biblical passage or an expression similar or like “God's power is greater than any problem you have, give your problems to God and let him guide you to resolution.” A thought provoking message may be one similar or like those delivered by the “DAILYZEN” found at www.dailyzen.com—“With a quiet mind come into that empty house, your heart, and feel the joy of the way beyond the world. Look within, the rising and the falling. What happiness!! How sweet to be free!” as originally said by Buddha in the Dhammapada. And, psycho-suggestive messages may include horoscopes, astrological predictions from sound sources, etc. In accordance with the present invention, such psycho-suggestive messages may be recorded by recognized experts and may include musical themes and other media presentations such as graphical images, which may be displayed on graphic screens (e.g., digital displays, etc.). Accordingly, psycho-suggestive messages in accordance with the present invention are to be interpreted as thought provoking communications that are intended to bring about a more positive outlook towards one's personal circumstances and personal challenges.

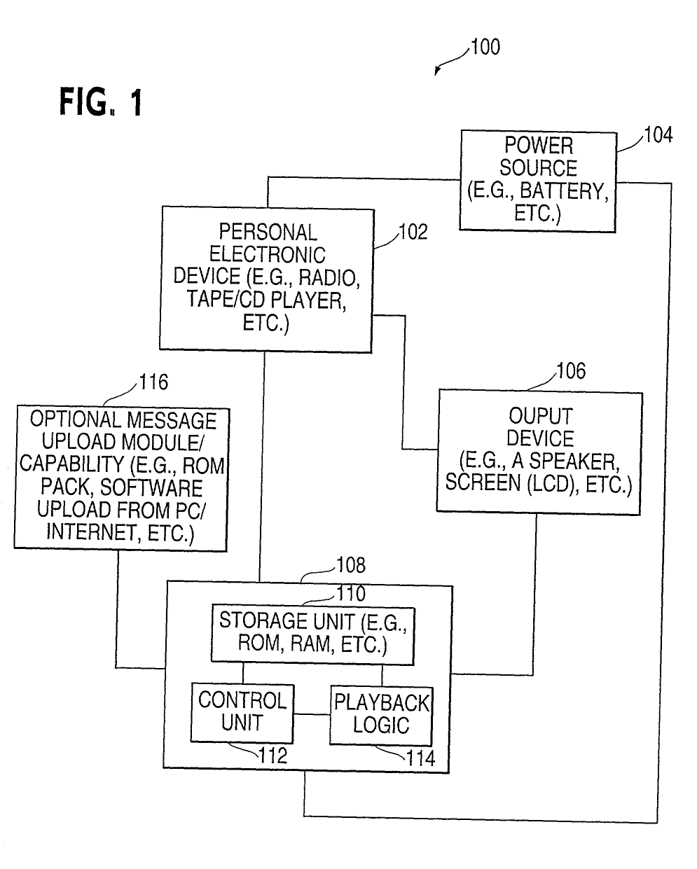

Referring now to FIG. 1, depicted therein is an apparatus for delivering psycho-suggestive and other motivational messages to a user. In particular, apparatus 100 includes a personal electronic device (P.E.D.) such as a radio device, a tape player, a CD player, MP3 player, a personal entertainment device, such as a game machine, etc. A power source 104 is coupled to personal electronic device 102 as well as to apparatus 108. apparatus 108 includes the components necessary to facilitate delivery of psycho-suggestive and other motivational type messages. In particular, apparatus 108 comprises a storage unit such as one including a non-volatile memory such as a RAM, or other memory storage device such as RAM enabled devices, a control unit 112, and playback logic 114 which may be encapsulated within a non-volatile memory and/or within a software system. An output device 106 may include a speaker, a screen such as an LCD screen and other combinations thereof. The control unit 112 in conjunction with the storage unit and the playback logic as shown are used to automatically play or otherwise manifest digitally recorded media such as voice based messages. The storage and playback of digitally recorded information such as voice based data, music data, etc. will be readily understood by those skilled in the art—for example, those skilled in the art will readily appreciate the playback of voice and other media data that is stored in MICROSOFT compatible “.WAV” file formats, in j-peg (.JPG) format, MP3 formats, etc. While these storage conventions are mentioned, the present invention is not so limited—in fact, any suitable digital recording methodology may be used that facilitates compact digital storage of voice and other data and which further facilitates effective playback and manifestation of the same via speakers and other devices like screens, etc. The present invention simply requires data such as a voice message, for example, to be digitally stored such as in a non-volatile memory like or similar to a read only memory (ROM) device, to be automatically retrieved therefrom, and manifested via corresponding playback logic units and output devices.

Additionally, apparatus 100 may include an optional message upload module/capability 116. For example, a ROM pack, software uploaded from a PC/internet connection etc. may be used to upload new and ever-changing psycho-suggestive messages that are digitally recorded. Additionally, apparatus 100 may be configured with wireless upload capabilities to allow psycho-suggestive messages to be wirelessly uploaded to memory. Such wireless communications may be achieved via radio broadcast, cellular communications, digital cellular, PCS, etc.

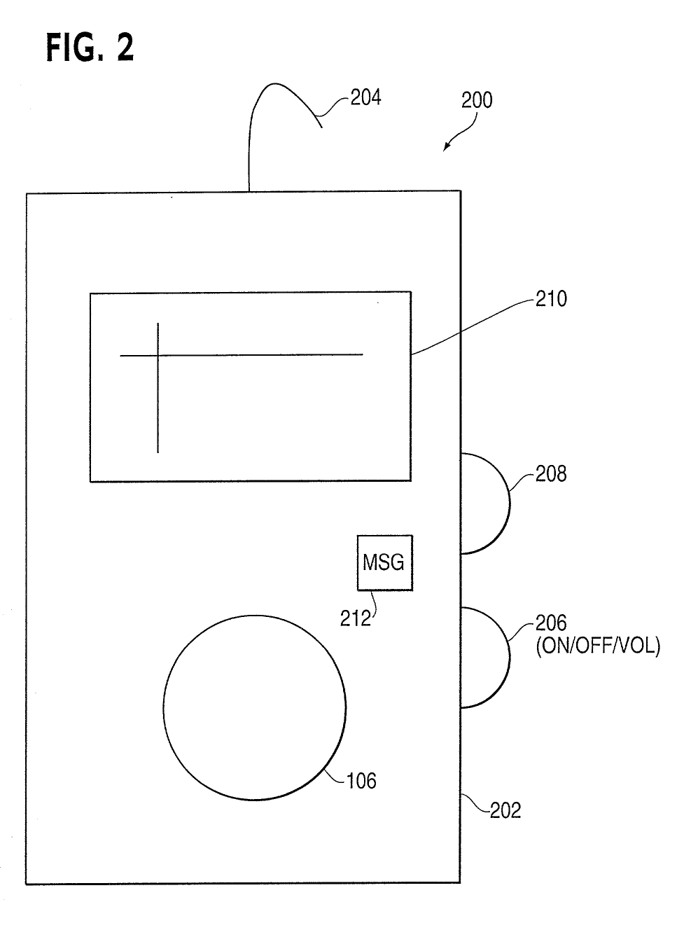

Referring now to FIG. 2, depicted therein is an exemplary embodiment of a personal electronic device in the form of a shower stall radio that may be used within a shower stall. In particular, shower stall radio 200 includes a case 202 constructed of a material suitable for a moist environment such as plastic such that case 202 may be referred to as a water resistant case. Additionally, shower stall radio 200 includes a hook member 204 which may be a bendable member similar or like a rubber coated bendable metal tube, etc. to allow shower stall radio 200 to be placed upon a faucet or showerhead pipe and be secured thereto. Additionally, an on/off switch 206 may be used to control the operating state of shower radio 200 and volume thereof. A tuning dial 208 may be used in conjunction with tuning display 210 to select stations such as radio stations and the like. Speaker 106 is used to manifest broadcast content as well as psycho-suggestive messages, which may be played with the context of the present invention.

In particular, message button 212 will allow a user to press the same and receive an audible psycho-suggestive message. Such a psycho-suggestive message may be manifested via speaker 106. In the event that the shower radio 200 is operating and is currently playing music, for example, such operations can be interrupted to play a psycho-suggestive message when message button 212 is pressed. In this way, a person waking up in the morning and taking a shower before work, can press message button 212 and hear a psycho-suggestive message when they are in the shower, for example. Accordingly, the structure shown within FIG. 1, may be outfitted with appropriate date, and optionally time, circuitry and logic to play a different message each day of the year, etc. And, if apparatus 100 is outfitted within shower radio 200, the same may be further outfitted with an upload capability to allow additional psycho-suggestive messages to be uploaded or placed into operation within apparatus 100 to allow alternative psycho-suggestive and other motivational messages to be played within a personal electronic device such as shower stall radio 200.

It should be noted, that as shown in FIG. 2 a shower stall radio is merely exemplary. That is, any personal electronic device may be used such as personal tape records, personal dictation machines, personal video games, and any other personal electronic device that may be used and which may incorporate an apparatus to facilitate the delivery of psycho-suggestive and other motivational messages. And, alternatively, apparatus 100 may be configured as a stand-alone device that merely delivers psycho-suggestive messages.

It should be noted that while shower stall radio only shows a single apparatus operation button (message button 212), the present invention is not so limited. To the contrary, as with any modern content playback device, other operation buttons and functions (and logic) would be included within shower stall radio 200. For example, in the event that multiple messages are stored in and/or uploaded to shower stall radio 200, operation buttons and functions (and logic) to cause advancement of messages, replay of messages, backup to a particular message, etc. may be included. Accordingly, the embodiments shown herein are merely exemplary and are meant to illustrate the flexibility of the present invention to be suited to many commercial applications and products.

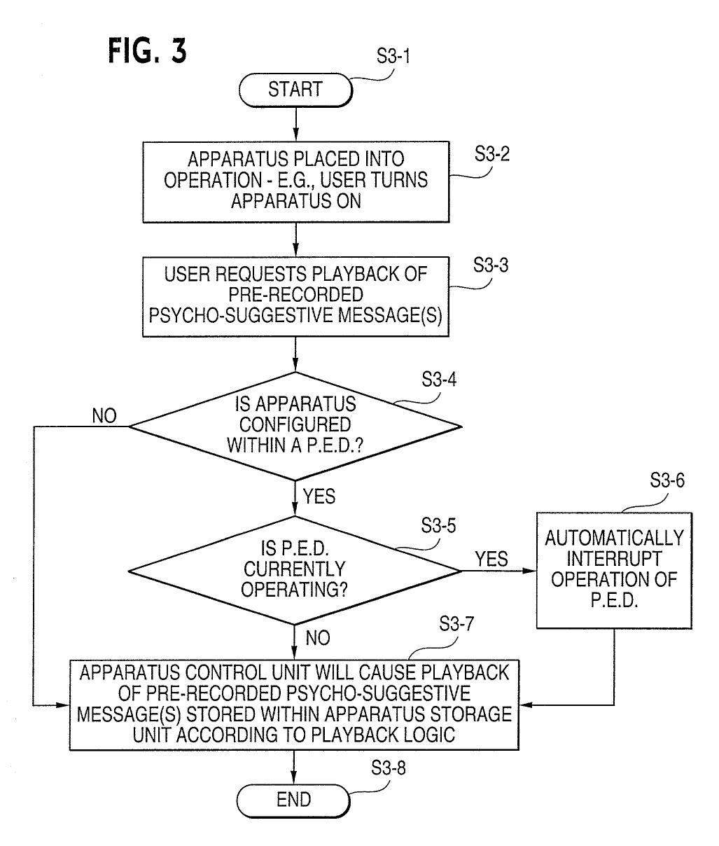

The structure shown within FIG. 1 and 2 are designed to operate together to facilitate the delivery of psycho-suggestive and other motivational messages. Such operations are illustrated and exemplified in FIG. 3 to which reference is now made.

Referring now to FIG. 3, depicted therein is a flow chart that illustrates a general flow chart for facilitating delivery of psycho-suggestive messages in the context of the present invention. In particular, processing and operations start at step S3-1 and immediately proceed to step S3-2. At step S3-2, an apparatus like or similar to apparatus 100 (FIG. 1) is placed into operation such as by a user turning the apparatus (e.g., the shower stall radio shown in FIG. 2, etc.) on.

Next, at step S3-3 the user may request playback of a pre-recorded psycho-suggestive or other motivational message. Such a request may be carried out in accordance with a manual operation realized with switch 212 (FIG. 2).

Next, a determination will be made as to whether or not the apparatus such apparatus 100 is configured within a personal electronic device or is a stand-alone device. If the apparatus is configured within the personal electronic device, operations and processes continue at step S3-5. At step S3-5, a determination will be made as to whether or not the personal electronic device is currently operating. For example, the determination may be one that considers whether the personal electronic device is a radio or MP3 that is currently playing a radio broadcast, or some other digitally recorded content/music, respectively. If the determination at step S3-5 is affirmative, processes and operations continue at step S3-6.

At step S3-6, operation of the personal electronic device will be automatically interrupted. Next, at step S3-7 (which also follows from a negative determination at step S3-4) the apparatus control unit will cause playback of prerecorded psycho-suggestive message(s) and/or other motivational message(s) stored within the apparatus storage unit according to appropriate playback logic. Step S3-7 should include: the control unit can also be configured with the appropriate circuitry that will select a predetermined message based on the date and/or time at which the playback is initiated. Any pattern of message playback can be chosen, e.g., a different message for each day of the week, a different message for each day of the month, random message selection, particular messages for holidays and other special occasions. By the phrase “predetermined,” it is meant that the control unit comprises circuitry or other information that specifies when a particular messaged is to be played. For instance, it can specify that message 1 is played on Mondays, message 2 on Tuesday, etc. That is, in the event that such psycho-suggestive messages are digital recorded voice messages, the playback logic will cause a digitally recorded voice message file to be automatically manifested via speaker 106 (FIG. 1). The playback of digitally recorded voice data is well known in the art. For example, a .WAV file may be used to facilitate manifestation of digitally recorded voice content. And, such logic may include the temporal playback of content such as day of week messages, message of the day messages, etc., which are triggered, based on calendar logic and the like. In the event that apparatus 100, for example, is outfitted with 365 pre-recorded psycho-suggestive messages, a new message may be played daily. Alternatively, if apparatus 100 is configured with an upload capability, appropriate logic may be added to play new or past pre-recorded psycho-suggestive messages.

Processing and operations ends at step S3-8.

Having described the present invention by way of example with reference to the attached drawing figures, it will be readily understood an appreciated by those skilled in the art that many modifications and changes may be made to the present invention without departing from the spirit or scope of the present invention which is defined in the appended claims and their equivalents.

We claim:

1. An apparatus for delivering a pre-recorded psycho-suggestive message to a person, comprising:
a personal electronic device configured to perform a function;
storage means for digitally storing at least one pre-recorded psycho-suggestive message; and
playback means for playing said pre-recorded psychosuggestive message for perception by said person,
whereby said personal electronic device is prevented from performing said function when said playback means plays said at least one psycho-suggestive message.

2. An apparatus of claim 1, further comprising a control means for selecting the psycho-suggestive message, which is to be played by said playback means.

3. The apparatus according to claim 1, wherein said personal electronic device is a radio and said function is the manifestation of received broadcasted radio content.

4. The apparatus according to claim 3, wherein radio includes a water-resistant case configured to be placed into operation in a shower stall.

5. The apparatus according to claim 1, wherein said storage means includes a solid state memory unit configured to digitally store said at least one pre-recorded psycho-suggestive message.

6. The apparatus according to claim 5, wherein said solid state memory unit is a read-only memory (ROM).

7. The apparatus according to claim 1, wherein said playback means includes a speaker configured to audibly manifest said at least one pre-recorded psycho-suggestive message.

8. A method for delivering a pre-recorded psycho-suggestive message to a person, comprising the steps of:
a personal electronic device configured to perform a function;
digitally storing at least one pre-recorded psychosuggestive message in a storage device;
interrupting operation of a personal electronic device; and
playing said at least one pre-recorded psycho-suggestive message stored in said storage device for perception by said person after said operation of said personal electronic device is interrupted during said interrupting step.

9. The method according to claim 8, wherein said personal electronic device is a radio.

10. The method according to claim 9, wherein radio includes a water-resistant case configured to be placed into operation in a shower stall.

11. The method according to claim 8, wherein said storage device includes a solid state memory unit configured to digitally store said at least one pre-recorded psycho-suggestive message.

12. The method according to claim 11, wherein said solid state memory unit is a read-only memory (ROM).

13. The method according to claim 8, wherein said playing step includes playback of said at least one pre-recorded psychosuggestive message by way of a speaker.

14. A shower stall radio, comprising:
a radio unit configured to audibly manifest a radio broadcast;
storage means for digitally storing at least one pre-recorded psycho-suggestive message; and
playback means for playing said pre-recorded psycho-suggestive message for perception by a person,
whereby said radio unit is prevented from manifesting said radio broadcast when said playback means plays said at least one psycho-suggestive message.

15. The shower stall radio according to claim 14, further comprises a water-resistant case configured to be placed into operation in a shower stall.

16. The shower stall radio according to claim 14, wherein said storage means includes a solid state memory unit configured to digitally store said at least one pre-recorded psycho-suggestive message.

17. The shower stall radio according to claim 16, wherein said solid state memory unit is a read-only memory (ROM).

18. The shower stall radio according to claim 14, wherein said playback means includes a speaker configured to audibly manifest said at least one pre-recorded psycho-suggestive message.
